(19) United States
(12) Patent Application Publication
(10) Pub. No.: US 2008/0256680 A1
(43) Pub. Date: Oct. 23, 2008

(54) REMOVABLE DRAG RESCUE DEVICE, TURNOUT COAT, AND METHOD OF ASSEMBLY

(76) Inventors: Semra Peksoz, Stillwater, OK (US); Donna Branson, Stillwater, OK (US); Vincent Gil Vargas Quevedo, Stillwater, OK (US); Tricia L. Hock, Newark, OH (US); John M. Karban, Chesterfield, OH (US); Stacy L. Boland, Seville, OH (US); James J. Cabot, Brook Park, OH (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/736,282

(22) Filed: Apr. 17, 2007

(51) Int. Cl. A41D 13/00; A62B 35/00

(52) U.S. Cl. 2/93; 294/140

(57) ABSTRACT

A removable drag rescue device, a method of assembling a firefighter's turnout coat to include the drag rescue device, and a coat produced thereby. The drag rescue device comprises a pair of loops which are placed in the interior of an outer shell of the coat by insertion through a pair of apertures in the shell. The drag rescue device further comprises a handle portion between the two loops which remains outside of the back of the shell for grasping and use.

### FIELD OF THE INVENTION

The present invention relates to a removable drag rescue device for firefighters, a method of assembling a turnout coat to incorporate the drag rescue device, and the turnout coat produced thereby.

### BACKGROUND OF THE INVENTION

The National Fire Protection Association, a consensus standards writing organization, requires that every firefighter's turnout coat include a drag rescue device which can be used by a rescuer to pull a downed firefighter out of harm's way. The drag rescue devices used heretofore have typically consisted of a single loop of webbing material installed and formed by inserting each end of an elongate webbing strap into the outer shell of the coat through a separate hole and then sewing the inserted ends of the strap together. Consequently, the prior art drag rescue device cannot be removed from the coat without destroying the threaded connection between the ends of the strap.

When the prior art non-removable drag rescue device (DRD) is installed in the firefighter's coat, a portion of the DRD strap extending between the two insertion holes in the back of the shell remains outside of the coat and provides a handle which the rescuer can grab and pull. When the DRD handle is pulled, the remaining portion of the strap/loop within the coat draws up tightly, typically around each of the firefighter's arms at the shoulder.

Because of its design and the manner in which it must be installed, the prior art non-removable DRD has numerous significant shortcomings. For example, because the ends of the DRD strap cannot be sewn together until the individual ends of the strap are inserted into the interior of the coat, the installation of the DRD complicates the coat manufacturing process and makes the process more difficult, time-consuming, and labor intensive. In addition, because the prior art device consists of a single loop, the device becomes completely non-operational if it is broken at any given point.

The prior art non-removable DRD also makes the cleaning, maintenance, and repair of the turnout coat more difficult, time-consuming, and costly. In order to remove the inner lining of the coat from the shell, as well as to remove and/or replace the non-removable DRD, the threaded or other permanent attachment of the ends of the DRD strap must be broken. Moreover, when reassembling the turnout coat after cleaning or repair, the cleaning and repair personnel are responsible for properly reinstalling either the old DRD or a new DRD and then sewing or otherwise permanently attaching the ends of the DRD strap together within the coat. This greatly increases the risk that the DRD will not be installed or sewn together properly.

In addition to these disadvantages, the portion of the prior art non-removable device projecting from the back of the coat for use as a pull handle typically consists of only a single thickness of material. This makes the projecting handle more susceptible to breakage when pulled and also limits the useful life of the device. The exterior handle of the prior art non-removable DRD typically also is oriented in a vertical position, thus making the handle more difficult to grasp and pull.

### SUMMARY OF THE INVENTION

The present invention provides an improved DRD for firefighters, a method of assembling a turnout coat to incorporate the improved DRD, and an improved coat produced thereby. The DRD, turnout coat, and method of assembly provided by the present invention alleviate the problems and satisfy the needs discussed above. Unlike the prior art DRD, the inventive DRD is produced in finished form independently of the coat manufacturing process. Thus, the inventive DRD device is inserted into the coat in completed form and can be easily removed from the coat without breaking or damaging the DRD in any way. The inventive DRD can even be quickly removed and replaced in the field. Consequently, the installation of the inventive DRD in the firefighter's turnout coat does not interfere in any way with the coat manufacturing process. Nor must the inventive DRD be broken apart and then re-sewn or otherwise reconstructed by the cleaning and repair personnel.

The inventive DRD also provides a horizontal handle of double thickness which is stronger and is easier to pull and grasp. In addition, the inventive DRD provides separate rescue loops around each of the firefighter's arms so that, if one of the loops is broken, the device can still be used to pull the firefighter to safety.

In one aspect, there is provided a drag rescue device for a firefighter's turnout coat comprising a single piece of strap material wherein portions of the single piece of strap material have been placed in an overlaid position against each other and attached together in the overlaid position in a manner such that a first segment of the single piece of strap material forms a first loop for receiving the firefighter's right arm, a second segment of the single piece of strap material forms a second loop for receiving the firefighter's left arm, and at least one other segment of the single piece of strap material forms a handle extending between the first and the second loops for grasping and pulling the drag rescue device.

In another aspect, there is provided a method of assembling a turnout coat and there is also provided an inventive turnout coat assembled in accordance with the method. The inventive method comprises the steps of: (a) placing a first loop of an already completed drag rescue device in an interior of an outer shell of the turnout coat by inserting the first loop through a first aperture in a back portion of the outer shell; (b) placing a second loop of the already completed drag rescue device in the interior of the outer shell by inserting the second loop through a second aperture in the back portion of the outer shell, the second aperture being different from the first aperture; and (c) placing at least one liner in the interior of the outer shell by (i) inserting a right sleeve of the liner through the first loop and into a right sleeve of the outer shell and (ii) inserting a left sleeve of the liner through the second loop and into a left sleeve of the outer shell. The already completed drag rescue device used in the inventive method also further comprises a handle portion between the first and the second loops such that, following steps (a) and (b), at least a portion of the handle portion extends between the first and the second apertures outside of the back portion of the outer shell.

Further aspects, features, and advantages of the present invention will be apparent to those of ordinary skill in the art upon examining the accompanying drawings and upon reading the following detailed description of the preferred embodiments.

### BRIEF DESCRIPTION OF THE DRAWINGS

FIG. 1 illustrates an embodiment 2 of the inventive drag rescue device (DRD) 2.

FIG. 2 is a perspective view of a handle portion 10 of the inventive DRD 2.

FIG. 3 is a rear elevational view of an inventive firefighter's turnout coat 20 having the inventive DRD 2 installed therein.

FIG. 4 is another elevational rear view of the inventive firefighter's turnout coat 20 showing the operating position of the DRD handle 10.

FIG. 5 is another elevational rear view of the inventive firefighter's turnout coat 20 showing a flap 40 installed on the back of the turnout coat 20 for covering and protecting the DRD handle 10.

FIG. 6 is another rear view of the inventive turnout coat 20 showing a rescuer grasping the DRD handle 10 for use of the inventive DRD 2.

### DETAILED DESCRIPTION OF THE PREFERRED EMBODIMENTS

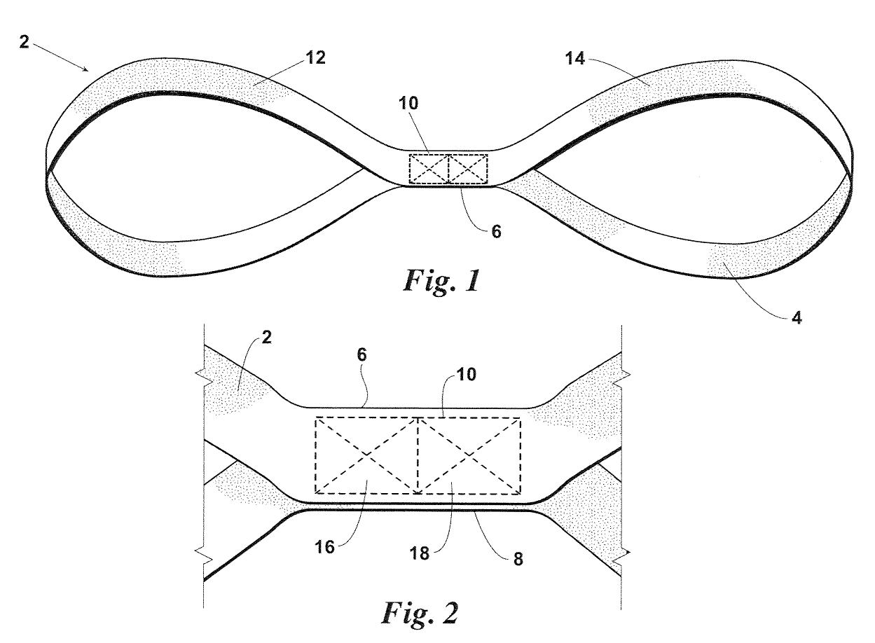

An embodiment 2 of the inventive drag rescue device (DRD) is illustrated in FIGS. 1 and 2. The inventive DRD is preferably formed of a single piece of strap material 4 having a first segment 6 thereof which is overlaid against an opposing segment 8 of the strap 4 and is attached to the opposing segment 8 in the overlaid position. The overlaid attachment of segment 6 on the opposing segment 8 will preferably be of a permanent nature such as by sewing or any other suitable technique.

The overlaid attachment of segment 6 to the opposing segment 8 of the strap 4 provides a double thick handle segment 10 which can be grasped and pulled by a rescuer for dragging a downed firefighter to safety. The overlaid attachment of the opposing first and second segments 6 and 8 of the strap 4 also serves to form a first loop 12 on one side of the handle 10 for receiving the firefighter's left arm and a second loop 14 on the other side of the handle 10 for receiving the firefighter's right arm. The first and second overlaid segments 6 and 8 forming the handle 10 are preferably selected such that the first and second loops 12 and 14 are substantially the same size. Each of loops 12 and 14 is also preferably a fixed permanent loop.

As one option, the first segment 6 of the strap material 4 which is attached in an overlaid position on segment 8 can consist of the two ends 16 and 18 of an elongate piece of the strap material 4 which are doubled over and placed adjacent to each other on the opposing segment 8.

As another option, the single piece of strap material 4 can be in the form of a continuous loop such that the overlaid segments 6 and 8 are simply opposing segments on opposite sides of the continuous loop. The strap material 4 can be formed as a continuous loop during the manufacturing process. Alternatively, a continuous loop of the strap material can be formed by joining the two end portions of an elongate piece of the strap material together.

As an example of yet another alternative, the ends of a single elongate piece of strap material can be doubled over so that they are overlaid and attached at spaced apart locations. In this embodiment, the attachment of each of the ends will form a loop for one of the firefighter's arms but the handle of the DRD will only be a single thickness handle formed of only a single, non-overlaid segment of strap material extending between the two end attachments.

The strap material used for forming the inventive DRD can be any material which has sufficient strength and durability for use as a drag rescue device and for withstanding the heat, flame, water, and weather conditions encountered by firefighters. Examples of suitable materials include, but are not limited to, para-aramid woven webbings in multiple widths and colors. The inventive DRD will preferably be formed using a webbed strap material such as 1.5 inch wide Kevlar DRD webbing.

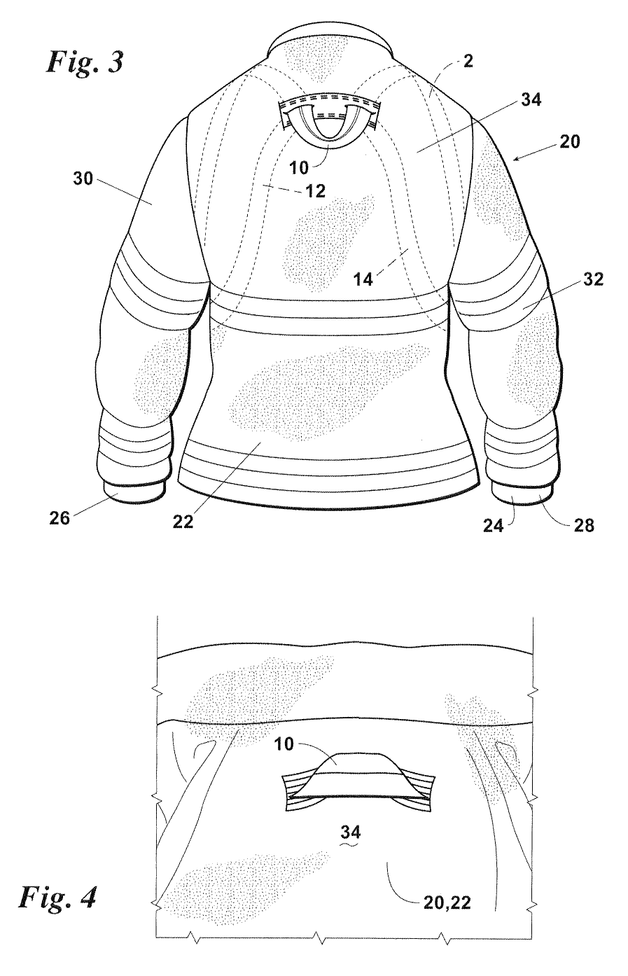

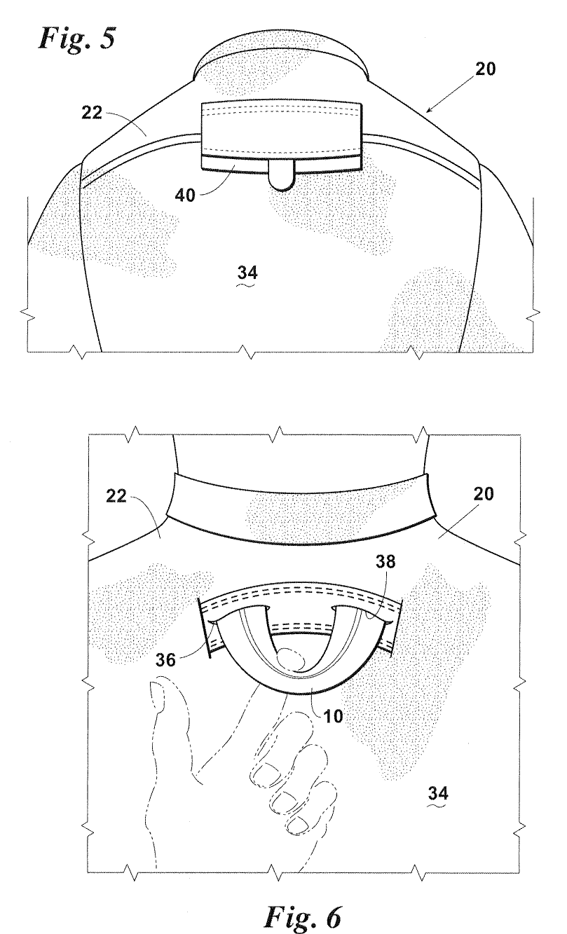

A firefighter's turnout coat 20 having the inventive DRD 2 installed therein is shown in FIGS. 3-6. The assembled turnout coat 20 also comprises an outer shell 22 and an inner liner 24 comprising a moisture barrier layer and a thermal barrier layer. When the inventive DRD 2 is installed in the turnout coat 20, the arm loops 12 and 14 of the inventive DRD 2 are positioned in the interior of the outer shell 22 such that the loops 12 and 14 are positioned between the outer shell 22 and inner liner 24. The left and right sleeves 26 and 28 of the inner liner 24 are inserted through the DRD loops 12 and 14 and into the left and right sleeves 30 and 32 of the outer shell 22.

As illustrated in FIGS. 3, 4, and 6, the handle portion 10 of the DRD 2 remains outside of the back portion 34 of the outer shell 22 and extends between two separate apertures 36 and 38 provided in the back of the shell 22. The apertures 36 and 38 are preferably diagonal or slanted horizontal slits which are spaced horizontally apart so that the handle 10 will extend horizontally outside of the shell 22 between the shoulders and above the firefighter's breathing equipment. A flap 40 including a Velcro™ attachment or other attachment device is preferably also attached to the back of the outer shell 22 above the handle apertures 36 and 38 for covering the exposed handle 10 to protect the handle 10 when not in use.

In contrast to the prior art devices, the inventive DRD can be conveniently installed and removed in completed form without having to either attach the ends of the device together after they are inserted into the coat or break the attachment between the ends so that the device can be removed.

The inventive method of assembling the turnout coat 10 to include the inventive DRD 2 preferably comprises the steps of: (a) placing the first loop 12 of the DRD 2 in the interior of the outer shell 22 by inserting the loop 12 through the shell aperture 36; (b) placing the second loop 14 of the DRD 2 in the interior of the outer shell 22 by inserting the second loop 14 through the other shell aperture 38, and then (c) installing the inner liner 24 in the outer shell 22. When installing an inner liner 24 in the outer shell 22, the left sleeve 26 of the liner 24 will be inserted through the left DRD loop 12 and into the left sleeve 30 of the shell 22 and the right sleeve 28 of the liner 24 will be inserted through the right loop 14 of the DRD and into the right sleeve 32 of the shell 22. When the loops 12 and 14 of the inventive DRD 2 are inserted respectively through the apertures 36 and 38 of the outer shell, the DRD handle 10 will automatically remain outside of the shell 22 in operating position as shown in FIGS. 3, 4, and 6.

To disassemble the inventive turnout coat 20 for cleaning, repair, or replacement of any part thereof, the inventive assembly method is simply reversed such that the inner liner 24 is preferably first removed from the shell 22 and from the DRD 2. The DRD loops 12 and 14 are then simply pulled out of the apertures 36 and 38 in the back of the outer shell 22.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

1. A drag rescue device for a firefighter's turnout coat comprising a single piece of strap material wherein portions of said single piece of strap material have been placed in an overlaid position against each other and attached together in said overlaid position in a manner such that a first segment of said single piece of strap material forms a first loop for receiving said firefighter's right arm, a second segment of said single piece of strap material forms a second loop for receiving a firefighter's left arm, and at least one other segment of said single piece of strap material forms a handle extending between said first and said second loops for grasping and pulling said drag rescue device.

2. The drag rescue device of claim 1 wherein said single piece of strap material is formed of a webbed material.

3. The drag rescue device of claim 1 wherein said handle is formed by said portions of said single piece of strap material which are attached together in said overlaid position.

4. The drag rescue device of claim 1 wherein said portions of said single piece of strap material are attached together in said overlaid position by sewing.

5. The drag rescue device of claim 1 wherein:
said single piece of strap material forms a continuous loop of said strap material and
said portions of said single piece of strap material which are attached together in said overlaid position are two opposing segments of said continuous loop different from said first and said second segments.

6. The drag rescue device of claim 5 wherein said two opposing segments are located on said continuous loop such that, when permanently attached together in said overlaid position, said first and said second loops will be of substantially equal size.

7. The drag rescue device of claim 1 wherein said portions of said single piece of strap material attached together in said overlaid position comprise:
an intermediate segment of said single piece of strap material;
a first end segment of said single piece of strap material overlaid on a first portion of said intermediate segment; and
a second end segment of said single piece of strap material overlaid adjacent to said first end segment on a second portion of said intermediate segment.

8. A method of assembling a turnout coat comprising the steps of:
(a) placing a first loop of an already completed drag rescue device in an interior of an outer shell of said turnout coat by inserting said first loop through a first aperture in a back portion of said outer shell;
(b) placing a second loop of said already completed drag rescue device in said interior of said outer shell by inserting said second loop through a second aperture in said back portion of said outer shell, said second aperture being different from said first aperture; and
(c) placing at least one liner in said interior of said outer shell by (i) inserting a right sleeve of said liner through said first loop and into a right sleeve of said outer shell and (ii) inserting a left sleeve of said liner through said second loop and into a left sleeve of said outer shell,
wherein said already completed drag rescue device further comprises a handle portion between said first and said second loops such that, following steps (a) and (b), at least a portion of said handle portion extends between said first and said second apertures outside of said back portion of said outer shell.

9. The method of claim 8 wherein said first and said second apertures are positioned horizontally apart such that said handle portion extends horizontally outside of said back portion of said outer shell.

10. The method of claim 8 wherein a cover flap is provided on said back portion of said outer shell for covering said handle portion.

11. The method of claim 8 wherein said completed drag rescue device is formed of a single piece of strap material wherein portions of said single piece of strap material have been placed in an overlaid position against each other and attached together in said overlaid position in a manner such that a first segment of said single piece of strap material forms said first loop, a second segment of said single piece of strap material forms said second loop, and at least one other segment of said single piece of strap material forms said handle extending between said first and said second loops.

12. The method of claim 11 wherein said single piece of strap material is formed of a webbed material.

13. The method of claim 11 wherein said handle is formed by said portions of said single piece of strap material which are attached together in said overlaid position.

14. The method of claim 11 wherein said portions of said single piece of strap are attached together in said overlaid position by sewing.

15. The method of claim 11 wherein:
said single piece of strap material forms a continuous loop of said strap material and
said portions of said single piece of strap material which are attached together in said overlaid position are two opposing segments of said continuous loop different from said first and said second segments.

16. The method of claim 11 wherein said portions of said single piece of strap material attached together in said overlaid position comprise:
an intermediate segment of said single piece of strap material;
a first end segment of said single piece of strap material overlaid on a first portion of said intermediate segment; and
a second end segment of said single piece of strap material overlaid adjacent to said first end segment on a second portion of said intermediate segment.

17. A turnout coat assembled by the method of claim 8.

18. A turnout coat assembled by the method of claim 9.

19. A turnout coat assembled by the method of claim 11.

20. A turnout coat assembled by the method of claim 13.

21. A coat comprising:
a segment of strap material with portions overlaid against one another and attached together to form two arm loops for receiving the arms of a wearer and to form a handle between the loops; and
a shell having two sleeves and an aperture on a back thereof;
wherein the loops are situated inside the shell so as to receive the arms of a wearer and the handle between the loops is accessible via the aperture.

22. The coat of claim 21, further comprising a liner inserted into the shell, the liner having sleeves that insert through the arm loops.

23. The coat of claim 21, wherein the segment of strap material comprises a single continuous loop, the loop being joined on opposite sides thereof to form the overlaid portions with the arms loops adjacent thereto.

24. The coat of claim 21, wherein the segment of strap material is comprised of a webbed material.

25. The coat of claim 21, wherein the overlaid portions are attached by sewing.

26. The coat of claim 21, wherein the segment of strap material comprises an elongate linear segment of material with first and second ends, the first and second ends being looped back and attached proximate a center of the strap to form the arm loops.

27. The coat of claim 26, wherein the first and second ends attach to the center of the strap in an overlaid configuration to form the handle.

28. The coat of claim 21, wherein the aperture has a cover that is closable over the handle when the handle is not in use.
